(19) United States
(12) Patent Application Publication
(10) Pub. No.: US 2007/0129455 A1
(43) Pub. Date: Jun. 7, 2007

(54) Swell-resistant polyurethane integral foams

(75) Inventors: Markus Schutte, Osnabruck (DE); Gitta Egbers, Osnabruck (DE); Cord Schmalkurche, Germering (DE); Marc Schwarz, Olching (DE); Wolfgang Pohl, Munchen (DE); Erich Lehnert, Olching (DE); Anja Biedermann, Diepholz (DE); Regina Pretzsch, Stemwede-Haldem (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/587,972

(22) PCT Filed: Feb. 19, 2005
(86) PCT No.: PCT/EP05/01756

§ 371 Date: Aug. 3, 2006

(30) Foreign Application Priority Data
Feb. 26, 2004 (DE) 10 2004 009 939.1

(51) Int. Cl. C08G 18/00

(52) U.S. Cl. 521/172

(57) ABSTRACT

The invention relates to swelling-resistant integral polyurethane foams obtainable by reacting polyisocyanate prepolymers (a) with a polyol mixture (b) comprising a polyether polyol (b1) based on a bifunctional starter molecule and a polyether polyol (b2) based on a trifunctional to pentafunctional starter molecule, with the polyols (b1) and (b2) being prepared by alkoxylation by means of ethylene oxide (hereinafter referred to as EO) and propylene oxide (hereinafter referred to as PO), having an ethylene oxide content of more than 50% by weight and at least 5% of the ethylene oxide being present as an EO end cap.

The invention relates to swelling-resistant integral polyurethane foams obtainable by reacting polyisocyanate prepolymers (a) with a polyol mixture (b) comprising a polyether polyol (b1) based on a bifunctional starter molecule and a polyether polyol (b2) based on a trifunctional to pentafunctional starter molecule, with the polyols (b1) and (b2) being prepared by alkoxylation by means of ethylene oxide (hereinafter referred to as EO) and propylene oxide (hereinafter referred to as PO), having an ethylene oxide content of more than 50% by weight and at least 5% of the ethylene oxide being present as an EO end cap.

Integral foams composed of polyurethane (PUR) have been known for a long time and have a number of technologically useful properties such as elasticity, energy-absorbing or thermally insulating properties combined with a low weight. The many areas of use include, inter alia, shoe soles, steering wheels or damping elements for the automobile industry. In the field of occupational safety shoes, shoe systems which are based on polyesterols and meet the requirements of DIN EN 344-1 are used as standard products. However, polyesterol systems have only a limited hydrolysis stability. Systems based on polyetherols have a considerably better hydrolysis stability, but do not meet the requirements in respect of swelling resistance in the presence of petroleum spirit.

WO 99/07761 describes flexible polyurethane foams for shoe soles which have been produced from a polyetherol mixture comprising a polyetherol having an EO content of more than 25% and an EO end cap and a random EO-PO polyetherol having an EO content of more than 60%. Here,“EO” is used as an abbreviation for the repeating unit CH₂—CH₂—O and “PO” is used for CH₂—CH₂—CH₂—O. The document gives no indication of advantageous hydrolysis or swelling properties, and the systems disclosed are not advantageous in respect of the mechanical properties.

Swelling-resistant polyurethane materials are described in DE-A-199 27 188. The swelling resistance is achieved by use of a mixture of polyesterols and polyetherols comprising from 60 to 85% of propylene oxide and from 40 to 15% of ethylene oxide. Hybrid systems composed of polyesterols and polyetherols are frequently undesirable because of the poor processability combined with poor use properties.

EP-B-939 780 B1 describes the use of a specific polyetherol component comprising PO and EO in a ratio of from 60:40 to 85:15 for producing fuel-resistant safety clothing and shoe soles. However, the systems disclosed are suitable only for producing shoe soles having densities above 800 g/l.

It was therefore an object of the present invention to provide polyurethane foams which
a) over a density range from 250 g/l to 1200 g/l display, firstly, good swelling properties in the presence of nonpolar media (i.e., for example, low volume increase on contact with nonpolar liquids) and, secondly, have good hydrolysis properties, and
b) have good mechanical properties such as tensile strength, tear propagation resistance and elongation.

In particular, it was an object of the present invention to provide polyurethane foams which, over a density range from 250 g/l to 1200 g/l, are suitable for producing shoe soles which, firstly, in respect of swelling resistance conform to the standard EN 344-1 clause 4.8.9. and, secondly, in respect of hydrolysis stability conform to the standard EN 344-1 clause 4.8.6 or the aging resistance in accordance with DIN 53543, clause 6.2, or the aging resistance in accordance with DIN EN ISO 2440 (rapid aging test). The aging resistance in accordance with DIN 53543, clause 6.2, is preferably to be achieved.

The object was able to be achieved by integral polyurethane foams which have been produced by means of a specific, high-EO polyol component.

The invention accordingly provides an integral polyurethane foam obtainable by reacting
a) a polyisocyanate prepolymer with
b) a polyether polyol mixture comprising the constituents
b1), a polyether polyol prepared by alkoxylation of a bifunctional starter molecule by means of ethylene oxide and propylene oxide, with the ethylene oxide content being more than 50% by weight, based on 100 percent by weight of alkylene oxides and starter molecule, and at least 5% of the ethylene oxide being present as an EO end cap, and
b2) a polyether polyol prepared by alkoxylation of a trifunctional or tetrafunctional starter molecule by means of ethylene oxide and propylene oxide, with the ethylene oxide content being more than 50% by weight, based on 100 percent by weight of alkylene oxides and starter molecule, and at least 5% of the ethylene oxide being present as an EO end cap, and
c) chain extenders.

The integral polyurethane foams of the invention are generally integral foams in accordance with DIN 7726. In a preferred embodiment, the invention provides integral foams based on polyurethanes having a Shore hardness in the range from 20 to 90 A, preferably from 30 to 80 Shore A, measured in accordance with DIN 53 505. Furthermore, the integral foams of the invention preferably have tensile strengths of from 2 to 20 N/mm², preferably from 2.5 to 18 N/mm², measured in accordance with DIN 53504. In addition, the integral foams of the invention preferably have an elongation of from 100 to 800%, preferably from 220 to 700%, measured in accordance with DIN 53504. Finally, the integral foams of the invention preferably have a tear propagation resistance of from 2 to 45 N/mm, preferably from 4 to 38 N/mm, measured in accordance with DIN 53507.

In particular, the polyurethanes of the invention are elastomeric flexible integral polyurethane foams.

The polyisocyanates (a) used for producing the polyurethane foams of the invention comprise the aliphatic, cycloaliphatic and aromatic isocyanates known from the prior art and any mixtures thereof. Examples are diphenylmethane 4,4′-diisocyanate, the mixtures of monomeric diphenylmethane diisocyanates and homologues of diphenylmethane diisocyanate containing a larger number of rings (polymeric MDI), tetramethylene diisocyanate, hexamethylene diisocyanate (HDI), tolylene diisocyanate (TDI) or mixtures thereof.

Preference is given to using 4,4′-MDI and/or HDI. The particularly preferred 4,4′-MDI can comprise small amounts up to about 10% by weight of allophanate-or uretonimine-modified polyisocyanates. It is also possible to use small amounts of polyphenylenepolymethylene polyisocyanate (crude MDI). The total amount of these high-functionality polyisocyanates should not exceed 5% by weight of the isocyanate used.

The polyisocyanates (a) can also be used in the form of polyisocyanate prepolymers. These prepolymers are known in the prior art. They are prepared in a manner known per se by reacting above-described polyisocyanates (a), for example at temperatures of about 80° C., with compounds (b) described below which have hydrogen atoms which are reactive toward isocyanates to form the prepolymer. The polyol/polyisocyanate ratio is generally selected so that the NCO content of the prepolymer is from 8 to 25% by weight, preferably from 10 to 24% by weight, particularly preferably from 13 to 23% by weight.

As compounds (b) having hydrogen atoms which are reactive toward isocyanates, it is possible to use compounds which bear two or more reactive groups selected from among OH groups, SH groups, NH groups, NH₂ groups and CH-acid groups, e.g. β-diketo groups, in the molecule. Depending on the choice of component (b), the term polyurethane as used for the purposes of the present invention comprises polyisocyanate polyaddition products in general, for example also polyureas.

A polyetherol mixture is used as component (b). The polyether polyols used are generally prepared by known methods, for example from one or more alkylene oxides selected from among propylene oxide (PO) and ethylene oxide (EO) by anionic polymerization using alkali metal hydroxides such as sodium or potassium hydroxide or alkali metal alkoxides such as sodium methoxide, sodium or potassium ethoxide or potassium isopropoxide as catalysts with addition of at least one starter molecule comprising from 2 to 4 reactive hydrogen atoms in bound form or by cationic polymerization using Lewis acids such as antimony pentachloride, boron fluoride etherate, etc., or bleaching earth as catalysts.

It is also possible to use polyetherols having a low unsaturated content as polyetherols (b). For the purposes of the present invention, polyols having a low unsaturated content are, in particular, polyether alcohols having a content of unsaturated compounds of less than 0.02 meq/g, preferably less than 0.01 meq/g. Such polyether alcohols are prepared by addition of ethylene oxide and/or propylene oxide and mixtures thereof onto at least bifunctional alcohols in the presence of double metal cyanide catalysts.

The alkylene oxides can be used individually, alternately in succession or as mixtures. The use of an EO/PO mixture leads to a polyether polyol having a random distribution of PO/EO units. It is possible firstly to use a PO/EO mixture and then, before stopping the polymerization, to use only PO or EO, thus giving a polyether polyol having a PO or EO end cap.

Possible starter molecules are, for example: water, organic dicarboxylic acids such as succinic acid, adipic acid, phthalic acid and terephthalic acid, aliphatic and aromatic, optionally N-monoalkyl-, N,N-dialkyl- and N,N′-dialkyl-substituted diamines having from 1 to 4 carbon atoms in the alkyl radical, e.g. optionally monoalkyl- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexa-methylenediamine, aniline, phenylenediamines, 2,3-, 2,4-, 3,4- and 2,6-tolylenediamine and 4,4′-, 2,4′- and 2,2′-diaminodiphenylmethane.

Further possible starter molecules are: alkanolamines such as ethanolamine, N-methyl- and N-ethylethanolamine, dialkanolamines such as diethanolamine, N-methyldiethanolamine and N-ethyldiethanolamine and trialkanolamines such as triethanolamine and ammonia.

It is also possible to use dihydric, trihydric or tetrahydric alcohols such as ethanediol, 1,2- and 1,3-propanediol, diethylene glycol, dipropylene glycol, 1,4-butanediol, 1,6-hexanediol, glycerol and/or pentaerythritol.

The constituents (b1) and (b2) are polyether polyols which have been prepared by alkoxylation of a divalent or trivalent or tetravalent starter molecule by means of ethylene oxide and propylene oxide. It is important for the purposes of the invention that the constituents (b1) and (b2) have an ethylene oxide content of more than 50% by weight, based on 100 percent by weight of alkylene oxide. In a preferred embodiment, the polyether polyols (b1) and (b2) have an ethylene oxide content of from 60 to 85% by weight, particularly preferably from 70 to 80% by weight.

It is also important for the purposes of the invention that at least 5% of the added-on ethylene oxide in the constituents (b1) and (b2) is present as an EO end cap. In a preferred embodiment, from 8 to 30%, more preferably from 9 to 25%, particularly preferably from 10 to 22%, of the ethylene oxide, based on 100 percent by weight of alkylene oxide, is present as an EO end cap.

A further important aspect of the invention is that the polyether polyol (b1) is prepared by alkoxylation of a divalent starter molecule or a mixture of a plurality of divalent starter molecules. Diethylene glycol or propylene glycol or dipropylene glycol is preferably used for this purpose.

Another important aspect of the invention is that the polyether polyol (b1) is prepared by alkoxylation of a trivalent or tetravalent starter molecule or a mixture of a plurality of trivalent or tetravalent starter molecules. Preference is given to using trivalent starter molecules, for example glycerol or trimethylolpropane.

The amounts of the polyether polyols (b1) and (b2) are preferably matched in such a way that the resulting polyether polyol mixture (b) has an actual functionality of from 2.01 to 2.8, preferably from 2.05 to 2.6, particularly preferably from 2.1 to 2.6. For the present purposes,“actual” functionality is the functionality which is obtained by measuring the actual OH number, measuring the actual (number average) molecular weight and subsequently calculating the functionality according to the formula:
Functionality=Molecular weight×56100/OH number.

In contrast thereto, the theoretical functionality frequently reported in the literature is the functionality of the starter molecule to be alkoxylated. In general, the polyether polyols (b1) and (b2) have a number average molecular weight of from 400 to 8000 g/mol, preferably from 800 to 6000 g/mol, particularly preferably from 2000 to 4000 g/l.

Chain extenders are used as component (c). Suitable chain extenders are known in the prior art. Preference is given to using 2- and 3-functional alcohols having molecular weights below 400 g/mol, in particular in the range from 60 to 150 g/mol. Examples are ethylene glycol, propylene glycol, diethylene glycol, 1,4-butanediol, glycerol and trimethylolpropane. Preference is given to using monoethylene glycol.

The chain extender is usually used in an amount of from 5 to 20% by weight, preferably from 7 to 16% by weight, particularly preferably from 9 to 15% by weight, based on the total weight of the components (b) and (c).

In a preferred embodiment, the constituents are used in the following amounts:
(b1) in an amount of from 15 to 80% by weight, preferably 20 to 70% by weight,
(b2) in an amount of from 1 to 30% by weight, preferably 1.5 to 25% by weight, and
(c) in an amount of from 5 to 20% by weight, preferably 9 to 16% by weight, based on the total weight of the components (b) and (c).

In the reaction of the polyisocyanate prepolymer (a) and the polyol mixture (b), it is possible, if appropriate, to add further compounds having hydrogen atoms which are reactive toward isocyanates. Examples of such compounds are predominantly PO-containing polyetherols or polymer polyols. It is preferred that essentially no polyester polyols are added in the reaction.

The reaction of the components (a) and (b) may, if appropriate, be carried out in the presence of blowing agents. Blowing agents which can be used are generally known chemically or physically acting compounds. As chemically acting blowing agent, preference is given to using water. Examples of physical blowing agents are inert (cyclo)aliphatic hydrocarbons which have from 4 to 8 carbon atoms and vaporize under the conditions of polyurethane formation. The amount of blowing agents added depends on the desired density of the foams. In general, the blowing agent is used in such an amount that densities of the molded parts of from 250 g/l to 1200 g/l, preferably from 250 to 600 g/l or from 800 to 1200 g/l (depending on the application, see information below), are achieved.

As catalysts for producing the polyurethane foams of the invention, use is made of the customary and known polyurethane formation catalysts, for example organic tin compounds such as tin diacetate, tin dioctoate, dibutyltin dilaurate and/or strongly basic amines such as diazabicyclooctane, triethylamine or preferably triethylenediamine or bis(N,N-dimethylaminoethyl) ether. The catalysts are preferably used in an amount of from 0.01 to 10% by weight, preferably from 0.02 to 5% by weight.

The reaction of the components a) and b) may, if appropriate, be carried out in the presence of (e) auxiliaries and/or additives such as cell regulators, mold release agents, pigments, reinforcing materials such as glass fibers, surface-active compounds and/or stabilizers against oxidative, thermal, hydrolytic or microbial degradation or aging.

The polyurethanes of the invention preferably comprise sheet silicates. The use of these sheet silicates, which are preferably present in delaminated, also referred to as exfoliated, form, enables the swelling resistance of the preferably microcellular polyurethane elastomers to be additionally improved. As sheet silicates, it is possible to use the silicate structures having two-dimensional layers of SiO₄ tetrahedra which are known from the prior art (also known as phyllosilicates in the prior art). Examples of suitable sheet silicates are bentonite, talc, pyrophyllite, mica, serpentine, kaolinite and mixtures thereof. Preference is given to using bentonite. The sheet silicates used according to the invention are preferably in modified form. The modification comprises intercalation of compounds (ii) between the layers according to methods known from the prior art. The intercalation is effected by replacement of the cations comprised in the sheet lattice of the silicates by these generally known compounds. In a preferred embodiment, the intercalation of compounds leads to modified sheet silicates having a sheet spacing of from 1 to 2 nm. The compound (ii) is preferably a quaternary ammonium compound, with particular preference being given to stearylbenzyldimethylammonium with counteranion, preferably stearylbenzyldimethylammonium chloride and/or stearylbenzyldimethylammonium sulfate, very particularly preferably stearylbenzyldimethylammonium chloride. The sheet silicates are commercially available from Südchemie, Southern Clay, Nanocor and LY-TEC, Laviosa Chimica under, inter alia, the trade names Nanofil® 2, Nanofil® 32, Nanofil® 9, Nanofil® 919, Cloisite® 10 A, Cloisite® 30B, SCPX 1138, SCPX 439, Dellit® 43 B. In general, the modified sheet silicates (i) which are preferred according to the invention and preferably comprise (ii) are used in an amount of from 0.1 to 20% by weight, preferably from 0.5 to 15% by weight, particularly preferably from 0.5 to 10% by weight, in particular from 0.8 to 4% by weight, based on the total weight of the polyol component. Reaction of the modified sheet silicates used according to the invention with the polyisocyanate component results in the former being exfoliated and being incorporated as exfoliated sheet silicates into the polyurethane matrix. The term “exfoliated” generally means that the sheet spacing of the silicate sheets is so large or that the sheets are so irregularly arranged that no sheet spacing can be determined by the customary measurement methods. Particular preference is therefore given, according to the invention, to integral polyurethane foams comprising sheet silicates, preferably modified sheet silicates. The sheet silicates are particularly preferably present in exfoliated form. The sheet silicates can preferably be added to the polyol component in the production of the integral foams. Exfoliation of the sheet silicates can be effected in the polyol component prior to reaction with the isocyanates or else during the reaction of the polyol component comprising the sheet silicates with the isocyanates.

In general, the component (a) is referred to as isocyanate component and the component (b) in admixture with the components (c) and, if appropriate, blowing agents and additives is referred to as polyol component.

The invention further provides a process for producing integral polyurethane foams by reacting
a) a polyisocyanate prepolymer with
b) a polyol mixture comprising the constituents
b1) a polyether polyol prepared by alkoxylation of a bifunctional starter molecule by means of ethylene oxide and propylene oxide, with the ethylene oxide content being more than 50% by weight, based on 100 percent by weight of alkylene oxides and starter molecule, and at least 5% of the ethylene oxide being present as an EO end cap, and
b2) a polyether polyol prepared by alkoxylation of a trifunctional or tetrafunctional starter molecule by means of ethylene oxide and propylene oxide, with the ethylene oxide content being more than 50% by weight, based on 100 percent by weight of alkylene oxides and starter molecule, and at least 5% of the ethylene oxide being present as an EO end cap, and
c) chain extenders.

The above-described preferred embodiments of the integral polyurethane foam of the invention likewise apply to the process of the invention.

The process of the invention is preferably carried out in molds with compaction. The molds preferably comprise metal, e.g. steel or aluminum, or plastic, e.g. epoxy resin. The starting components are mixed at temperatures of from 15 to 90° C., preferably from 20 to 35° C., and introduced, if appropriate under superatmospheric pressure, into the (preferably closed) mold. Mixing can be effected during introduction by means of high- or low-pressure mixing heads known in the prior art. The temperature of the mold is generally from 20 to 90° C., preferably from 30 to 60° C.

The amount of reaction mixture introduced into the mold is such that the moldings obtained have a density of from 250 to 600 g/l or from 800 to 1200 g/l, preferably from 400 to 600 g/l or from 820 to 1050 g/l. The degrees of compaction of the resulting integral foams, i.e. the moldings having a compacted surface zone and a cellular core, are in the range from 1.1 to 8.5, preferably from 1.5 to 7, particularly preferably from 2 to 6.

To produce polyurethane foams, the components (a) and (b) are generally reacted in such amounts that the equivalence ratio of NCO groups to the sum of reactive hydrogen atoms is from 1:0.8 to 1:1.25, preferably from 1:0.9 to 1:1.15. A ratio of 1:1 corresponds to an NCO index of 100.

The integral polyurethane foams of the invention are used for steering wheels, safety clothing and preferably for shoe soles, in particular outer shoe soles and middle shoe soles.

The invention thus provides, in addition to the polyurethane foams of the invention, an outer shoe sole having a density of from 800 to 1200 g/l, preferably from 820 to 1050 g/l, and comprising the integral polyurethane foams of the invention. For the purposes of the present invention, the density of the polyurethane foam is the average density over the total resulting foam, i.e. in the case of integral foams this figure is the mean density of the total foam including core and outer layer. The integral foams are preferably produced as described above in a mold, so that the density of the resulting foam is also referred to as the density of the molded part.

The invention further provides a middle shoe sole having a density of from 250 to 600 g/l, preferably from 400 to 600 g/l, and comprising the integral polyurethane foams of the invention.

The shoe soles of the invention display low swelling in polar liquids, for example in petroleum spirit or isooctane. They can therefore be advantageously used for producing fuel-resistant shoe soles or shoe soles which are swelling-resistant in fuel.

The invention therefore provides for the use of an outer shoe sole or middle shoe sole according to the invention for producing swelling-resistant shoe soles which display swelling of less than 12% in accordance with EN 344-1 clause 4.8.9. and thus conform to this standard.

Furthermore, the shoe soles of the invention display good hydrolysis behavior. They can therefore advantageously be used for producing hydrolysis-stable and swelling-resistant shoe soles.

The invention therefore provides for the use of an outer shoe sole or middle shoe sole of the invention for producing swelling-resistant shoe soles which conform to the standard EN 344-1 clauses 4.8.9. and 4.8.6.

The outer shoe soles or middle shoe soles of the invention are preferably used for producing swelling-resistant shoe soles which conform to clause 4.8.9. of the standard EN 344-1 and pass the aging resistance test of DIN 53 543, clause 6.2, and/or DIN EN ISO 2440 (rapid aging test).

The aging resistance test of DIN 53 543, clause 6.2, and DIN EN ISO 2440 (rapid aging test) is carried out as follows:

Test specimens having dimensions of 200×200×10±0.5 mm are foamed using the polyurethane shoe sole systems of the invention. Before commencement of the aging tests, the initial values of tensile strength and elongation are determined in accordance with DIN 53 504 and the tear propagation resistance is determined in accordance with DIN 53 507. The specimens are then subjected to an aging test at 70° C. under water. Sampling is carried out after 7 and 14 days. The residual tensile strength of the specimens has to be 100% of the initial value.

### EXAMPLES

Starting Materials Used:

Polyol 1: polyether polyol, OHN=42, nominal functionality f=3, ratio of EO/PO=75/25, EO cap of 10% by weight
Polyol 2: polyether polyol, OHN=51, nominal functionality f=2, ratio of EO/PO=71/29, EO cap of 15% by weight
Polyol 3: polyether polyol, OHN=29, nominal functionality=2, ratio of PO/EO=80/20, EO cap
Polyol 4: polyether polyol, OHN=35, nominal functionality=3, ratio of PO/EO=85/15, EO cap
Polyol 5: polyether polyol, OHN=27, nominal functionality=2.49, ratio of PO/EO=80/20, EO cap
CE 1: monoethylene glycol
CE 2: 1,4-butanediol
Stabilizer: Dabco DC 193®(Air Products)
C1: tin catalyst,
C2: amine catalyst,
Tixogel: spherical SiO₂ nanoparticles from Südchemie
Cloisite 30B: nano-sheet silicate from Südchemie
ISO 500®, ISO 137/28®, ISO MP102®:
   isocyanate prepolymers from Elastogran based on 4,4′-MDI and a polyether polyol
NCO content=18.0% for ISO 137/28®, 22.9% for MP102® and 20.4% for ISO 500®
   Production of the Integral Foams:

The A and B components were intensively mixed in the mixing ratios described in the examples (see Table 1) at 23° C. and the mixture was introduced into a plate-shaped aluminum mold having dimensions of 20×20×1 cm which had been heated to 50° C. in such an amount that an integral foam plate resulted after foaming and curing in the closed mold.

TABLE 1
Overview of systems

| Polyol | | | | | | | | | | | |
|---|---|---|---|---|---|---|---|---|---|---|---|
| mixture | Comp. 1 | Comp. 2 | Comp. 3 | Comp. 4 | 1a | 1b | 1c | 2 | 3 | 4 | 5 |
| Polyol 1 | | | | | 22.3 | 23.0 | 14.0 | 17.4 | 1.7 | 23.0 | 23.0 |
| Polyol 2 | | | | | 60.3 | 42.6 | 68.8 | 21.5 | 84.5 | 42.6 | 42.6 |
| Polyol 3 | 26.6 | | 26.6 | 26.6 | | | | | | | |
| Polyol 4 | 13.3 | 46.2 | 13.3 | 13.3 | | | | | | | |
| Polyol 5 | 42.3 | 45.5 | 42.3 | 42.3 | | 18.7 | | 50.2 | | 18.7 | 18.7 |
| Stabilizer | 0.3 | 0.15 | 0.3 | 0.3 | 0.3 | 0.3 | 0.3 | 0.3 | 0.25 | 0.3 | 0.3 |
| CE 1 | 1.4 | 6.3 | 1.4 | 1.4 | 13.7 | 11.8 | 14 | 9.17 | 13.5 | 11.8 | 11.8 |
| CE 2 | 12.7 | | 12.7 | 12.7 | 1.0 | 1.0 | 1 | | | 1.0 | 1.0 |
| C 2 | 2.4 | 1.3 | 2.4 | 2.4 | 2.0 | 2.0 | 2.0 | 1.4 | 1.3 | 2.0 | 2.0 |
| C 1 | 0.05 | 0.03 | 0.05 | 0.05 | 0.05 | 0.05 | 0.05 | 0.05 | 0.04 | 0.05 | 0.05 |
| Water | 0.4 | 0.4 | 0.4 | 0.4 | 0.4 | 0.4 | 0.4 | 0.2 | 0.2 | 0.4 | 0.4 |
| Tixogel | | | 10 | | | | | 2 | | 2 | |
| Cloisite 30B | | | | 10 | | | | | 2 | 2 | 2 |
| Isocyanate | ISO | MP- | ISO | ISO | ISO | ISO | ISO | MP-102 ® | ISO | ISO | ISO |
| component | 137/17 ® | 102 ® | 137-17 ® | 137-17 ® | 137/28 ® | 137/28 ® | 137/28 ® | | 500 ® | 137/28 ® | 137/28 ® |
| MR A:B = | 124 | 74 | 124 | 124 | 140 | 129 | 98 | 74 | 113 | 129 | 129 |
| 100 * x | | | | | | | | | | | |

Processing:

In all experiments, foams having free-foamed densities of from 260 to 300 g/l were produced. Double compaction thus gives densities of the molded parts of from 550 to 600 g/l. All experiments had the same cream times, rise times and buckling times. The dimensional stability after removal from the mold is comparable in all experiments. Important mechanical parameters such as tensile strength, elongation or flexural fatigue properties are likewise comparable.

Table 2 gives an overview of the processing properties and mechanical properties of the systems.

TABLE 2
Overview of processing properties and mechanical properties

| | Experiment | | | | | | | | | | |
|---|---|---|---|---|---|---|---|---|---|---|---|
| | Comp. 1 | Comp. 2 | Comp. 3 | Comp. 4 | 1a | 1b | 1c | 2 | 3 | 4 | 5 |
| Flexural fatigue test* | + | + | + | + | + | + | + | + | + | + | + |
| Swelling | − | − | − | − | + | + | + | + | + | + | + |
| Hydrolysis stability | + | + | + | + | + | + | + | + | + | + | + |

*+ = Crack growth after 100 kcycles <2 mm

Table 3 describes the effect of nanomaterials on the swelling behavior of selected systems.

TABLE 3
Swelling when nanomaterials are used

| | Comp. 3 | Comp. 4 | 5 | 4 |
|---|---|---|---|---|
| | (Tixogel | (Cloisite 30B | (Cloisite 30B | (Tixogel |
| Parts | in Comp. 1) | in Comp. 1) | in 1b) | in 1b) |
| 0 | 18.6 | 18.6 | 7.6 | 7.6 |
| 0.5 | | | 6.5 | 8.4 |
| 0.7 | | | 6.4 | |
| 2 | | | 6.8 | 8.3 |
| 10 | 18.7 | 17.8 | | |

The measured values were determined in accordance with the following prescribed methods:

Flexural fatigue test in accordance with DIN 53 543, swelling in accordance with DIN EN 344-1, hydrolysis stability in accordance with DIN 53 543, clause 6.2.

1-11. (canceled)

12. An integral polyurethane foam made by the process of reacting
(a) a polyisocyanate prepolymer with
(b) a polyether polyol mixture comprising the constituents
(b1) a polyether polyol prepared by alkoxylation of a bifunctional starter molecule by means of ethylene oxide and propylene oxide, with the ethylene oxide content being more than 50% by weight, based on 100 percent by weight of alkylene-oxides and starter molecule, and at least 5% of the ethylene oxide being present as an EO end cap, and
(b2) a polyether polyol prepared by alkoxylation of a trifunctional or tetrafunctional starter molecule by means of ethylene oxide and propylene oxide, with the ethylene oxide content being more than 50% by weight, based on 100 percent by weight of alkylene oxides and starter molecule, and at least 5% of the ethylene oxide being present as an EO end cap, and
(c) chain extenders.

13. The integral polyurethane foam according to claim 1, wherein the constituents are used in the following amounts:
(b1) in an amount of from 15 to 80% by weight,
(b2) in an amount of from 1 to 30% by weight and
(c) in an amount of from 5 to 20% by weight, based on the total weight of the components (b) and (c).

14. The integral polyurethane foam according to claim 12, wherein the constituents (b1) and (b2) have an ethylene oxide content of from 60 to 85% by weight.

15. The integral polyurethane foam according to claim 12 which is an integral flexible foam based on polyurethanes and having a Shore hardness in the range 20-90A, a tensile strength of up to 20 N/mm², an elongation of up to 800% and a tear propagation resistance up to 45 N/mm.

16. The integral polyurethane foam according to claim 12, wherein the integral polyurethane foam comprises sheet silicates.

17. The integral polyurethane foam according to claim 16, wherein the sheet silicates are exfoliated.

18. A process for producing integral polyurethane foams by reacting
(a) a polyisocyanate prepolymer with
(b) a polyol mixture comprising the constituents
(b1) a polyether polyol prepared by alkoxylation of a bifunctional starter molecule by means of ethylene oxide and propylene oxide, with the ethylene oxide content being more than 50% by weight, based on 100 percent by weight of alkylene-oxides and starter molecule, and at least 5% of the ethylene oxide being present as an EO end cap, and
(b2) a polyether polyol prepared by alkoxylation of a trifunctional or tetrafunctional starter molecule by means of ethylene oxide and propylene oxide, with the ethylene oxide content being more than 50% by weight, based on 100 percent by weight of alkylene oxides and starter molecule, and at least 5% of the ethylene oxide being present as an EO end cap, and
(c) chain extenders.

19. An outer shoe sole having a density of from 800 to 1200 g/l and comprising an integral polyurethane foam according to claim 12.

20. A middle shoe sole having a density of from 250 to 600 g/l and comprising an integral polyurethane foam according to claim 12.

21. A method of producing swelling-resistant shoe soles which display swelling of less than 12% in accordance with EN 344-1 clause 4.8.9 by using an outer shoe sole according to claim 19.

22. A method of producing swelling-resistant and hydrolysis-stable shoe soles which conform to the standard EN 344-1 clauses 4.8.9. and 4.8.6 by using an outer shoe sole according to claim 19.

23. A method of producing swelling-resistant shoe soles which display swelling of less than 12% in accordance with EN 344-1 clause 4.8.9. by using a middle shoe sole according to claim 20.

24. A method of producing swelling-resistant and hydrolysis-stable shoe soles which conform to the standard EN 344-1 clauses 4.8.9. and 4.8.6 by using a middle shoe sole according to claim 20.
